(19) United States
(12) Patent Application Publication
(10) Pub. No.: US 2025/0202237 A1
(43) Pub. Date: Jun. 19, 2025

(54) METHOD FOR OPERATING AN INVERTER

(71) Applicant: SMA Solar Technology AG, Niestetal (DE)

(72) Inventors: Alexander Unru, Baunatal (DE); Mohamed Khshainy, Kassel (DE); Chokri Khalfet, Kassel (DE)

(21) Appl. No.: 19/071,993

(22) Filed: Mar. 6, 2025

Related U.S. Application Data
(63) Continuation of application No. PCT/EP2023/073898, filed on Aug. 31, 2023.

(30) Foreign Application Priority Data
Sep. 7, 2022 (DE) 10 2022 122 683.2

(51) Int. Cl. H02J 3/14; H02J 3/38; H02M 7/537

(52) U.S. Cl. CPC H02J 3/14; H02J 3/381; H02M 7/537

(57) ABSTRACT

The disclosure relates to a control method for operating an inverter in an energy grid that is connected to an energy supply grid via a controllable disconnecting switch. The method includes operating the inverter in a current-impressing mode when the disconnecting switch is closed, and monitoring the power supply network for a voltage drop. When a voltage drop is detected, the inverter operating mode is changed to a voltage-setting mode, wherein a provisional voltage is set by the inverter. After a predetermined period of time has elapsed after detection of the voltage drop, when the voltage drop persists, the disconnecting switch opens and the voltage set by the inverter is increased to the grid normal voltage. After a predefined time period after detection of the voltage drop, when failure of the energy supply grid does not persist, the inverter operates in the current-impressing mode.

This application is a Continuation of International Application number PCT/EP2023/073898, filed on Aug. 31, 2023, which claims the benefit of German Application number 10 2022 122 683.2, filed on Sep. 7, 2022. The contents of the above-referenced patent applications are hereby incorporated by reference in their entirety.

### DESCRIPTION

The disclosure relates to a method for operating an inverter and to an energy system.

### BACKGROUND

In recent decades, there has been a trend away from energy generation from fossil fuels. It is much more preferable to generate energy, especially electrical energy, from renewable energy sources. Electrical energy from renewable energy sources is provided by the energy sources in the form of direct current, which must first be converted into alternating current by inverters in order to be used by the producer himself or to be fed into an energy supply grid, especially an AC grid.

Various errors can occur in the energy supply grid, to which the inverter can react. For example, a short circuit error may occur in the energy supply grid, in which case the standard stipulates that the maximum possible power of the inverter must be fed into the energy supply grid. In another case, the energy supply grid may fail, making it impossible to feed electrical power into the grid or to withdraw power from it.

Methods are known from the prior art that can be used to detect the above-mentioned errors. However, it is desired that the partial grid in which both the energy sources and at least one inverter are located should continue to be supplied with electrical power. This transition from the supply of a partial grid by an energy supply grid to the supply of the partial grid as an island grid after it has been disconnected from the energy supply grid is not covered by the prior art.

DE 10 2019 116 254 A1 shows how to switch between a current-regulating operating mode and a voltage-regulating operating mode of an inverter.

Furthermore, a so-called STATCOM is known to stabilize an energy supply grid.

### SUMMARY

The method according to the disclosure for operating an inverter in a partial grid, which is connected to an energy supply grid via a controllable disconnecting switch, comprising:
operating the inverter in a current-impressing mode while a disconnecting switch is closed,
continuously monitoring the power supply grid for voltage drops during the current-impressing mode,
changing the inverter's operating mode to a voltage-setting mode when the voltage drop in the energy supply grid is detected, wherein a temporary voltage that is reduced from the grid normal voltage is set by the inverter,
after a specified period of time has elapsed since the grid failure was detected, if the voltage drop in the energy supply grid persists, opening the disconnecting switch and successively increasing the applied voltage to the grid normal voltage, and
after a specified period of time has elapsed after the grid failure has been detected, if the energy supply grid fails to resume, operating the inverter in the current-impressing mode.

The above method controls an inverter in an energy grid, also known as a partial grid, which can be disconnected from an energy supply grid and is disconnected under certain conditions. These conditions comprise a failure of the energy supply grid's ability to supply in the sense that the energy supply of the partial grid cannot be ensured by the energy supply grid, or in other words, that it is no longer possible to obtain electrical power from the energy supply grid.

In particular, it is advantageous in this context that an inverter, which is initially operated in a current-impressing mode, form the partial grid when disconnected from the energy supply grid, i.e. the voltage in the partial grid in a voltage-impressing mode.

In a current-impressing mode, an inverter synchronizes to a grid voltage, either of the energy supply grid or a partial grid, and regulates the current fed in. Consequently, as long as a power supply grid is supplying the partial grid with energy, i.e. the disconnecting switch between the partial grid and the power supply grid is closed, the inverter can be synchronized with the power supply grid and feed into the partial grid in accordance with the frequency, voltage and phase of the power supply grid.

In a voltage-impressing or voltage-setting mode, there is only insufficient grid voltage or no grid voltage at all from the energy supply grid or in the partial grid. If the method according to the disclosure detects that there is a voltage drop in the partial grid during the current-impressing mode, i.e. while the disconnecting switch to the energy supply grid is closed, the inverter switches to the voltage-impressing mode. The inverter then adjusts the voltage in the partial grid independently according to normative specifications with regard to voltage level and frequency. In Central Europe, the standard frequency is 50 Hz and the standard voltage is 230 V. However, the normative specifications may vary depending on the grid operator at the local level.

The voltage drop can be determined by any means of measuring a voltage. For example, a voltmeter may be connected to a line between the energy supply grid and the disconnecting switch. This means that a voltage provided by the energy supply grid directly in front of the disconnecting switch, i.e. the connection location to the partial grid, can be measured directly. Alternatively, a voltmeter can also be connected to the AC input of the inverter. If the built-in voltmeter detects a voltage drop in the energy supply grid, the inverter can switch its operation from a current-impressing to a voltage-setting mode without delay, for example by a signal transmission from an external voltmeter.

In one embodiment, a voltage drop in the energy supply grid is detected by the voltage drop of the energy supply grid being reduced by a threshold value, wherein the threshold value is, for example, 5%.

In other words, a voltage drop is detected when a voltage of the energy supply grid is reduced by at least the threshold value, for example, by 5%, compared to the grid normal voltage. This involves comparing the current voltage of the energy supply grid with the grid normal voltage. The grid normal voltage is the nominal voltage specified for the local or regional energy supply grid (230 V in Europe).

This embodiment offers several advantages when detecting a voltage drop. Even a slight voltage drop in the energy supply grid can be detected. This means that a gradual voltage drop can be detected early on, so that any delay in switching between the inverter's current-impressing mode and the voltage-impressing mode is minimal. The generation of an island grid in the partial grid and the supply of the partial grid with electrical power by the inverter are performed with little delay. As a result, consumers can be supplied with electrical power almost seamlessly.

If the voltage drop is merely a fluctuation in the voltage of the energy supply grid and the energy supply grid returns to the normal grid voltage after the fluctuation has ended, the method is terminated. However, if it is not restored as described above and the voltage of the energy supply grid gradually decreases, the inverter is already in voltage-setting mode and can take over the energy supply of the partial grid.

In one embodiment, the control method can be designed such that the voltage supplied by the inverter is the same frequency and in phase with the voltage before the voltage drop in the energy supply grid was detected. This embodiment includes, in particular, but is not limited to, the case where an energy supply grid returns to normal operation after the voltage drop. This means that the voltage drop is a temporary effect that is subsequently remedied by a return of the voltage of the energy supply grid to a nominal value. This embodiment facilitates the transition to normal operation, which is described in more detail below.

If a voltage drop occurs in the energy supply grid, the inverter of a sub-network switches from a current-impressing mode to a voltage-setting mode, as already described above. The voltage that the inverter injects into the partial grid in voltage-impressing mode is at the same frequency and in phase with the voltage before the voltage drop in the energy supply grid was detected. In the event that the energy supply grid is available again, the voltage phase at the inverter is not readjusted because the energy supply grid and the partial grid are in phase. It is therefore possible to quickly and easily switch to normal operation, in which the energy supply grid supplies the partial grid with electrical power.

In one embodiment, the control method can be designed in such a manner that the voltage supplied by the inverter is reduced by 10% to 30% compared to the grid standard voltage of the energy supply grid.

In one embodiment, the control method can be designed such that, when monitoring the partial grid for a voltage drop in the energy supply grid, if it is detected that the grid failure results from an uncorrectable short circuit error, the adjustment of the provisional voltage set by the inverter to the voltage last detected in the partial grid before the voltage drop was detected, and an immediate opening of the disconnecting switch.

This embodiment specifically addresses an uncorrectable energy supply grid short circuit error. This may be caused by a short-circuit of a line in the vicinity of the partial grid. To prevent the energy supply grid in the environment from collapsing, there is a normative requirement that, in the event of a short circuit error, inverters continue to feed power into the energy supply grid for a certain period of time, as far as possible and necessary. In this case, the inverter detects a short circuit error in the energy supply grid in that the voltage of the energy supply grid suddenly drops to a lower value, wherein a residual voltage in the energy supply grid can still be measured. For example, the voltage of the energy supply grid drops by 50%. If it is only a temporary short circuit error, the energy supply grid can be supported in such a manner that it does not fail completely due to a temporary short circuit error.

In the event of an uncorrectable short circuit error, the energy supply grid is not restored after the specified time. This means that even a further feed-in of electrical power by an inverter of a partial grid could not restore the energy supply grid. In order to prevent the partial grid from also failing, the control method according to the disclosure provides for the inverter to switch to voltage-setting mode and for the partial grid to be disconnected from the energy supply grid immediately. Disconnection from the energy supply grid is achieved, for example, via a disconnecting switch located between the energy supply grid and the partial grid. In the event of a short circuit error in the energy supply grid, a distinction can be made between a correctable short circuit error, which is no longer relevant when the energy supply grid is restored, and an uncorrectable short circuit error, which is not corrected within a specified time.

Furthermore, the inverter can distinguish a short circuit error from a grid failure in such a manner that the measurable voltage of the energy supply grid drops to 0 V in the event of a grid failure, i.e. the energy supply grid has no measurable voltage.

In one embodiment, the control method can be designed in such a manner that if, when monitoring the partial grid for a voltage drop in the energy supply grid, it is detected that the voltage drop in the energy supply grid results from a failure of the energy supply grid, the provisional voltage set by the inverter is adjusted to a voltage that is 90% of the voltage that was last detected before the failure of the energy supply grid was detected, and the disconnecting switch is opened immediately.

One aspect of the disclosure relates to an energy system having at least one inverter arranged to be controlled according to the method, and a disconnecting switch capable of disconnecting the power system from an energy supply grid.

### BRIEF DESCRIPTION OF THE FIGURES

In the following, the disclosure is represented with the aid of a FIGURE, wherein:

FIG. 1 is a flow chart of the control method according to the disclosure.

The FIGURE is explained in detail below.

### DETAILED DESCRIPTION

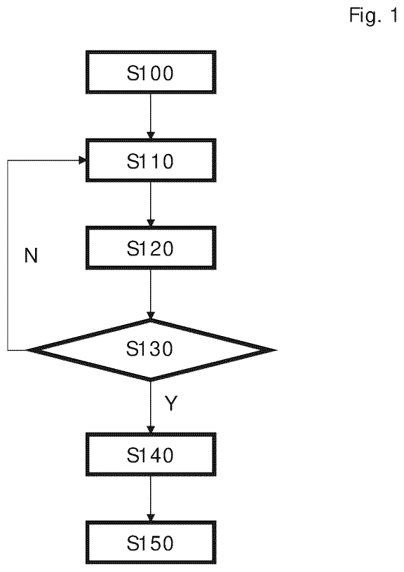

FIG. 1 is a flow chart of the control method according to the disclosure. The method starts at S100. S100 means the start of the method. In most cases, this happens by starting an inverter on which the control method runs. The method then continues at S110.

At S110, the inverter is operated in a current-impressing mode. In current-impressing mode, the inverter is synchronized to the voltage of the energy supply grid and feeds electrical power from a connected direct current source into a partial grid to which the inverter is connected. The energy supply grid is connected via a disconnecting switch to the partial grid to which the inverter is connected. For example, a voltmeter that continuously measures the voltage of the energy supply grid can be connected to the disconnecting switch in permanent connection with the energy supply grid. The method subsequently and continuously performs at S120.

At S120, the energy supply grid is monitored, for example, continuously monitored, for voltage drops. For this purpose, the voltage of the energy supply grid is measured by a voltage measuring device, such as a voltmeter. If a voltage drop is now detected at S130, the inverter switches to a voltage-setting mode. The voltage set is reduced by 10 to 30% of the grid normal voltage compared to the grid normal voltage of the energy supply grid.

Below is a case in which the voltage drop persists. If the voltage drop with residual voltage persists in the energy supply grid, it is determined after a specified time that an uncorrectable short circuit error is present. In this case, it is assumed that the energy supply grid has failed. In the event of a power failure, i.e. when no more voltage can be measured in the energy supply grid, it can be assumed that the voltage drop continues as soon as the power failure is detected. The method proceeds to S140 via decision Y at S130.

At S140, the disconnecting switch between the energy supply grid and the partial grid is opened, i.e. the power-transmitting connection between the energy supply grid and the partial grid is disconnected. The power of the inverter, which is now operated in voltage-setting mode, is fed into the partial grid, wherein the consumers in the partial grid are operated by this fed power. The inverter, whose supplied voltage is reduced compared to the grid normal voltage of the energy supply grid, is now increased to the grid normal voltage of the energy supply grid.

In another case, the voltage drop in the voltage of the energy supply grid decreases. In other words, the voltage of the energy supply grid increases from the temporarily reduced value due to a temporary error back to the normal grid voltage, so that the voltage of the energy supply grid is no longer reduced by a value greater than the threshold value. In this case, the method continues via S130: N and the method continues at S110, i.e. the inverter is operated in current-impressing mode again. After this change of mode of the inverter, the process proceeds again to the ongoing monitoring of the energy supply grid at S120.

What is claimed is:

1. A control method for operating an inverter in an energy grid connected to an energy supply grid via a controllable disconnecting switch, comprising:
operating the inverter in a current-impressing mode while the controllable disconnecting switch is closed,
monitoring the energy supply grid for voltage drops,
changing the inverter's operating mode to a voltage-setting mode when a voltage drop in energy supply grid is detected, wherein a temporary voltage that is reduced from a grid normal voltage is set by the inverter,
after a predetermined period of time has elapsed following detection of the voltage drop, when the voltage drop in the energy supply grid persists, opening the controllable disconnecting switch and increasing a voltage provided by the inverter to the grid normal voltage, and
after a preset period of time has elapsed after the voltage drop has been detected, when a failure of the energy supply grid does not persist, operating the inverter in the current-impressing mode.

2. The control method according to claim 1, wherein
the voltage drop of the energy supply grid is detected by the voltage of the energy supply grid being reduced by a threshold value.

3. The control method according to claim 2, wherein
the threshold value is at least 5% of the grid normal voltage.

4. The control method according to claim 1, wherein
the voltage provided by the inverter is selected with a same frequency and in phase with the voltage before the voltage drop of the energy supply grid is detected.

5. The control method according to claim 1, wherein
a preliminary voltage provided by the inverter is reduced by 10% to 30% compared to the grid normal voltage of the energy supply grid.

6. The control method according to claim 1, wherein, when monitoring the grid for a voltage drop of the energy supply grid, an uncorrectable short circuit error is detected, adjusting the temporary voltage provided by the inverter to the voltage that was last detected before the failure of the energy supply grid was detected and an immediate opening of the disconnecting switch.

7. The control method according to claim 1, wherein, when monitoring the partial grid for a voltage drop of the energy supply grid, a failure of the energy supply grid is detected, adjusting the temporary voltage provided by the inverter to a voltage that is 90% of the voltage that was last detected before the failure of the energy supply grid is detected, and an immediate opening of the disconnecting switch.

8. An energy system comprising at least one inverter adapted to be controlled according to the control method according to claim 1, and a disconnecting switch capable of disconnecting the energy system from an energy supply grid.
